(19) United States
(12) Patent Application Publication
(10) Pub. No.: US 2005/0226961 A1
(43) Pub. Date: Oct. 13, 2005

(54) System and method for monitoring the dispensing of an alcoholic beverage from a container

(76) Inventor: Bradley Emalfarb, Riverwoods, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/822,941

(22) Filed: Apr. 13, 2004

(51) Int. Cl. A23L 1/00

(52) U.S. Cl. 426/87

(57) ABSTRACT

The combination of a container having a storage space with a supply of an alcoholic beverage and a closure system that is operatively engageable with the container. The container has an unopened state and an opened state. The alcoholic beverage is confined to the storage space with the container in the unopened state and capable of being dispensed from the storage space for consumption with the container in the opened state. The container is detectably changeable as an incident of the container being changed from the unopened state into the opened state in a manner that the container cannot be changed from the opened state precisely back into the unopened state, as a consequence of which it can be determined by inspection that the container was changed from the unopened state into the opened state. The closure system has first and second different states. With the closure system operatively engaged with the container and in the first state therefor, the closure system prevents dispensing of the alcoholic beverage in the container from the storage space for consumption. The closure system is detectably changeable as an incident of the closure system changing from the first state into the second state in a manner that the closure system cannot be changed from the second state precisely back into the first state, as a consequence of which it can be determined by inspection that the closure system was changed from the first state into the second state. After changing the container from the unopened state into the opened state, the closure system can be operatively engaged with the container and placed in the first state so that thereafter any dispensing of the alcoholic beverage from the container for consumption requires changing of the closure system from the first state into the second state, which can be detected by inspection of the closure system.

### BACKGROUND OF THE INVENTION

1. Field of the Invention

This invention relates to containers for alcoholic beverages and, more particularly, to a system and method for monitoring dispensing of the alcoholic beverage from the container after the container has initially been opened.

2. Background Art

States have passed, and strictly enforce, laws regulating the possession of open containers of alcoholic beverages in motor vehicles. An operator or passenger is in violation of many of these laws simply by reason of having an open container with an alcoholic beverage therein, regardless of whether or not the alcoholic beverage is being consumed as the motor vehicle is operated. While these laws are lauded for the fact that they reduce the incidence of alcohol consumption by drivers and passengers in motor vehicles, they create problems in other instances in which those in possession of the open container with the alcoholic beverage therein have no intention of consuming the same while operating the motor vehicle.

Because of these strict “open container” laws, sales of alcoholic beverages by restaurateurs may be adversely affected. Many states have passed laws which now allow a bottle of wine, or other alcoholic beverage, which has been purchased and opened at a restaurant but not fully consumed, to be removed from the premises. The restaurant patron may legally transport an open bottle of wine from the restaurant, but may be precluded from legally transporting the open wine bottle in a motor vehicle from the restaurant to his/her end destination. Because of this situation, different scenarios are likely.

First, in order to avoid a wasted purchase of a container with an alcoholic beverage therein, the restaurant patron may stay at the restaurant longer than desired to consume the entire quantity of the alcoholic beverage purchased. The end result of this may be that the restaurant patron may consume more alcohol during his/her visit than intended. In the event that the patron is actually the driver of a motor vehicle, the additional consumption could contribute to the impairment of the individual's driving skills.

From the standpoint of the restaurateur, the open container laws have at least the following two detrimental effects. Patrons, nearing the end of a meal, may not order an additional bottle of wine or other container of alcoholic beverage, in anticipation that it will not be totally consumed before they conclude their visit. Rather than waste any of the investment in the alcoholic beverage, the individual/party may choose to forego the purchase altogether. This potentially results in a loss of business for the restaurant.

Alternatively, individuals or parties may linger in a restaurant, merely to make sure that the purchased alcoholic beverage is completely, or mostly, consumed. In busy establishments, this may limit the number of seatings in a given evening, which again potentially takes away revenue from the restauranteur.

The above problems may be likewise encountered by those in dedicated drinking establishments.

Ideally, open containers of alcohol could be somehow controlled for transportation in motor vehicles in a manner that would allow law enforcement officials to determine whether or not any consumption of the alcoholic beverage in the motor vehicle has occurred. To date, in most states, the letter of the law has been followed by law enforcement personnel to the detriment of bar owners, restaurateurs, and consumers.

### SUMMARY OF THE INVENTION

In one form, the invention is directed to the combination of a container having a storage space with a supply of an alcoholic beverage and a closure system that is operatively engageable with the container. The container has an unopened state and an opened state. The alcoholic beverage is confined to the storage space with the container in the unopened state and capable of being dispensed from the storage space for consumption with the container in the opened state. The container is detectably changeable as an incident of the container being changed from the unopened state into the opened state in a manner that the container cannot be changed from the opened state precisely back into the unopened state, as a consequence of which it can be determined by inspection that the container was changed from the unopened state into the opened state. The closure system has first and second different states. With the closure system operatively engaged with the container and in the first state therefor, the closure system prevents dispensing of the alcoholic beverage in the container from the storage space for consumption. The closure system is detectably changeable as an incident of the closure system changing from the first state into the second state in a manner that the closure system cannot be changed from the second state precisely back into the first state, as a consequence of which it can be determined by inspection that the closure system was changed from the first state into the second state. After changing the container from the unopened state into the opened state, the closure system can be operatively engaged with the container and placed in the first state so that thereafter any dispensing of the alcoholic beverage from the container for consumption requires changing of the closure system from the first state into the second state, which can be detected by inspection of the closure system.

In one form, the closure system has a case with a receptacle into which the container is placed with the closure system operatively engaged with the container.

In one form, the case has a flexible shape and an opening. The container is movable through the opening with the closure system in the second state. The opening is blocked sufficiently with the closure system in the first state that the container cannot be moved from the receptacle through the opening.

In one form, the case has hinged case parts which are movable towards and away from each other to selectively place the closure system in the first and second states.

In one form, the container has an opening through which the alcoholic beverage can be introduced into and dispensed from the storage space and a cork directed into the container opening with the container in the unopened state and separated from the container with the container in the opened state.

In one form, the container has a wall structure defining the opening and the closure system has at least one element that acts between the cork and the wall structure.

In one form, the at least one element is defined by a moldable material that is molded against the cork and the wall structure with the closure system in the first state.

In one form, the moldable material is ruptured to change the closure system from the first state into the second state.

In another form, the container has a wall structure defining an opening through which the alcoholic beverage can be introduced into and dispensed from the storage space for consumption and a cap that is repositionable relative to the wall structure to change the container between the open and unopened states.

In one form, the closure system has at least one element that acts between the cap and the wall structure.

In one form, the at least one element is made from a moldable material that is molded against the cap and the wall structure with the closure system in the first state.

In one form, the moldable material is ruptured to change the closure system from the first state into the second state.

In one form, the case has first and second wall parts that are connected, each to the other, with the closure system in the first state.

The first and second wall parts may be bonded to each with the closure system in the first state.

The first and second wall parts may be connected to each other through at least one flexible element with the closure system in the first state.

In another form, the first and second wall parts are connected to each other through a molded element with the closure system in the first state.

The first and second wall parts may be snap-connected to each other with the closure system in the first state.

In another form, the first and second wall parts are connected to each other through a fastener with the closure system in the first state.

The fastener may include joinable parts.

In one form, the container has an opening through which the alcoholic beverage can be introduced into and dispensed from the storage space for consumption and the closure system in the first state blocks the opening to prevent dispensing of alcoholic beverage in the container from the storage space for consumption.

The invention is further directed to a method of monitoring the dispensing of an alcoholic beverage from a container. The method includes the steps of: providing an alcoholic beverage in a storage space defined by a container having an unopened state and an opened state, the alcoholic beverage confined to the storage space with the container in the unopened state and capable of being dispensed from the storage space for consumption with the container in the opened state; changing the container from the unopened state into the opened state and thereby causing the container to be detectably changed in a manner that the container cannot be changed from the opened state precisely back into the unopened state, as a consequence of which it can be determined by inspection that the container was changed from the unopened into the opened state; providing a closure system that is operatively engageable with the container and having first and second different states; placing the closure system in the first state so as to prevent dispensing of the alcoholic beverage in the container from the storage space for consumption; and changing the closure system from the first state into the second state to allow the alcoholic beverage to be dispensed from the storage space for consumption and thereby causing the closure system to be detectably changed in a manner that the closure system cannot be changed from the second state precisely back into the first state, as a consequence of which it can be determined by inspection that the closure system was changed from the first state into the second state. After changing the container from the unopened state into the opened state, the closure system can be operatively engaged with the container and placed in the first state so that thereafter any dispensing of the alcoholic beverage from the container for consumption requires changing of the closure system from the first state into the second state which can be detected by inspection of the closure system.

### BRIEF DESCRIPTION OF THE DRAWINGS

FIG. 1 is a side elevation view of a container for an alcoholic beverage and with a primary closure system which maintains the container in an unopened state;

FIG. 2 is a view as in FIG. 1 with the primary closure system changed so that the container is in an opened state;

FIG. 3 is a side elevation view of a secondary closure system, according to the invention, including a flexible pouch operative engaged with the container in FIGS. 1 and 2 and with the secondary closure system in a first state;

FIG. 4 is a fragmentary, perspective view of a top portion of the flexible pouch on the secondary closure system of FIG. 3 with wall portions thereon separated to place the secondary closure system in a second state wherein the container can be directed therethrough;

FIG. 5 is an enlarged, cross-sectional view of the top of the flexible pouch taken along line 5-5 of FIG. 3 and showing one structure, according to the invention, for connecting the wall portions to close the opening in the pouch and thereby maintain the secondary closure system in the first state;

FIG. 6 is a flow diagram showing one method of monitoring the dispensing of an alcoholic beverage from a container, according to the present invention;

FIG. 7 is a view as in FIG. 5 showing a different structure to connect the wall portions of the flexible pouch together to close the pouch opening, according to the invention, together with a tool for operating the same;

FIG. 8 is a view as in FIG. 7 showing a snap-fit connection between the wall portions;

FIG. 9 is a view as in FIG. 4 and showing a two-part fastener that can be used to connect the wall portions on the flexible pouch to maintain the secondary closure system in the first state therefor;

FIG. 10 is a view as in FIG. 9 with the fastener parts connected and the secondary closure system in the first state;

FIG. 11 is a side elevation view of the fastener in FIG. 9 with each part engaged by a tool to allow the parts to be engaged by relative rotational movement;

FIG. 12 is a view as in FIG. 11 of a modified form of fastener, with parts that are engaged by relative translational movement;

FIG. 13 is a fragmentary, front elevation view of a modified form of case/flexible pouch defining a secondary closure system, according to the present invention, and including a folded flap that is maintained in a closed position by fasteners so as to place the secondary closure system with which the flap is associated in the first state;

FIG. 14 is a side elevation view of the top portion of the case/flexible pouch and flap in FIG. 13;

FIG. 15 is an enlarged view, as in FIG. 9, with the wall portions connected to each other by an adhered element;

FIG. 16 is a view as in FIG. 15 with a modified form of element which is flexible and wraps around the wall portions;

FIG. 17 is a perspective view of a modified form of secondary closure system, according to the present invention, and including a case with relatively movable parts shown in the state corresponding to that for the case/pouch in FIG. 4;

FIG. 18 is a view as in FIG. 17 with the case parts relatively moved to place the secondary closure system in the state corresponding to that for the case/pouch in FIG. 3, with the container in a receptacle defined by the case;

FIG. 19 in an enlarged, fragmentary, perspective view of the top of the container in FIGS. 1 and 2 and with a modified form of secondary closure system, according to the prevent invention, including an element acting between a cork and a wall structure on the container with the secondary closure system in a state corresponding to that for the case/pouch in FIG. 4;

FIG. 20 is a view as in FIG. 19 with the element ruptured and the secondary closure in a state corresponding to that for the case/pouch in FIG. 4;

FIG. 21 is a fragmentary, side elevation view of a further modified form of secondary closure system on a container, as in FIGS. 1 and 2, and in the form of a wrapper;

FIG. 22 is a top view of the container and secondary closure system of FIG. 21;

FIG. 23 is a fragmentary, side elevation view of the top of a container, as in FIGS. 1 and 2, with a further modified form of secondary closure system thereon in the form of a molded element;

FIG. 24 is a view as in FIG. 23 showing the molded element in cross-section;

FIG. 25 is a view as in FIG. 24 of a further modified form of secondary closure system, according to the present invention, including an element around which a band is formed;

FIG. 26 is a fragmentary, elevation view of a top of a container, with which the present invention can be used, and having a cap that is threadably connected to the remainder of the container and with the container in an unopened state;

FIG. 27 is a view as in FIG. 26 with the cap removed and the container in an opened state;

FIG. 28 is a fragmentary, perspective view of another form of container, with which the present invention can be practiced, and including a tab that can be separated to change the state of the container from an unopened state into an opened state;

FIG. 29 is a schematic representation of a system, according to the present invention, including a container and a secondary closure system;

FIG. 30 is a schematic representation of one form of container and a secondary closure system, according to the present invention; and

FIG. 31 is a view as in FIG. 30 of another form of system, according to the present invention, and including a secondary closure system which operatively engages with a container using a stopper.

### DETAILED DESCRIPTION OF THE DRAWINGS

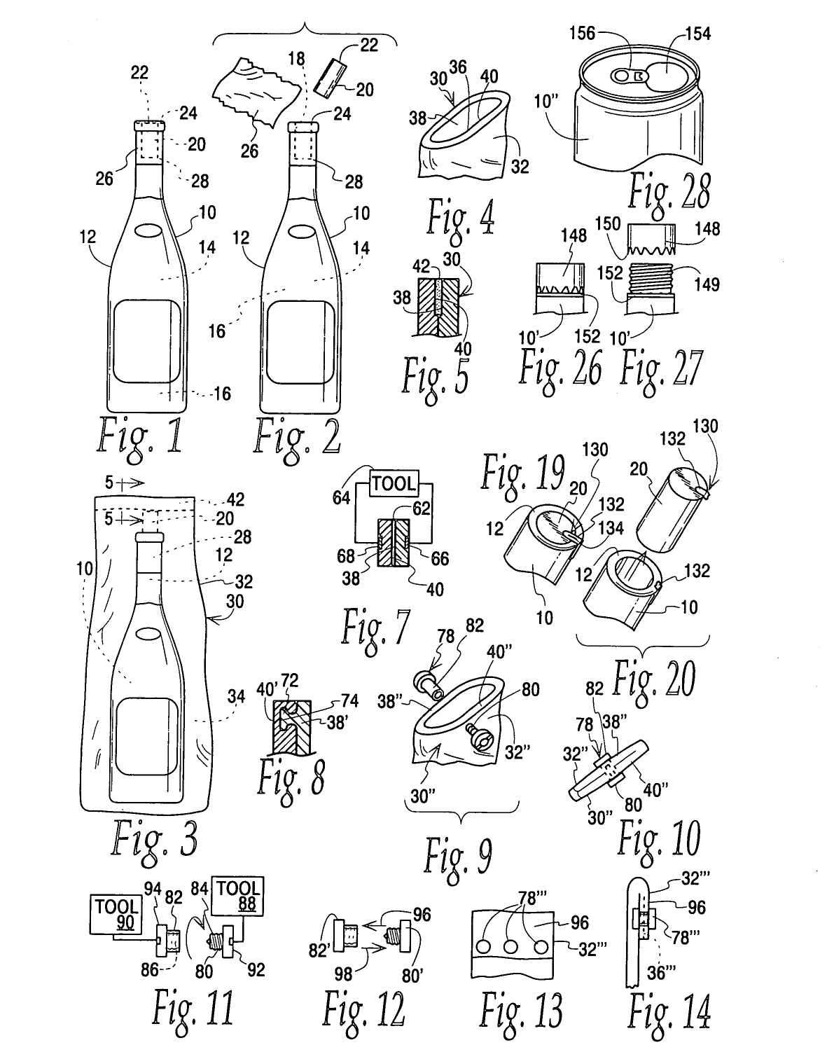

In FIGS. 1 and 2, a conventional container for an alcoholic beverage is shown at 10. The container 10 has a configuration typical of bottles used for wine, and the like. The container 10 has a wall structure 12, that may be made from glass or plastic. The wall structure 12 defines an internal storage space 14 for a supply of an alcoholic beverage 16. The top of the wall structure has an opening 18 through which the alcoholic beverage 16 is introduced into the storage space 14 and dispensed therefrom for consumption.

The container 10 has a primary closure system, in this case shown as a cylindrical cork 20. The cork 20 is dimensioned so that it can be pressed into the opening 18 and, by reason of being compressed, is frictionally maintained therein. Typically, the cork 20 is pressed into the opening 18 so that the top surface 22 of the cork 20 is substantially flush with the top edge 24 of the container 10. A wrapper 26, typically made from metal foil, is wrapped around a neck portion 28 of the container 10 and extends upwardly to over the top edge 24 of the container 10 and at least a portion of the top surface 22 of the cork 20.

In FIG. 1, the container 10 is shown in the unopened state therefor. In this state, the cork 20 prevents dispensing of the alcoholic beverage 16 through the opening 18 for consumption. To allow the cork 20 to be removed from the opening 18, the wrapper 26 must be torn. Merchants are able to determine that alcoholic beverage has not been dispensed from the storage space 14 so long as the wrapper 26 remains intact over the cork 20.

By tearing or altogether removing the wrapper 26, the cork 20 can be “pulled” from the container 10. With the cork 20 separated from the container 10, the container 10 is in an opened state wherein the alcoholic beverage 16 can be dispensed from the storage space 14 for consumption. Once the wrapper 26 is torn/removed and the cork 20 separated from the wall structure 12, the container 10 is detectably changed in a manner that the container 10 cannot be changed from the opened state precisely back into the unopened state. As a result, once the container 10 is changed into the opened state, it is possible for the merchant to detect, by inspection, that the alcoholic beverage 16 in the storage space 14 has been accessed. It is likewise possible for law enforcement personnel to determine that the container 10 is “opened” and therefore that the alcoholic beverage 16 in the storage space 14 is accessible for consumption, as in a moving vehicle.

The present invention is concerned with to the ability to control the “open container” 10 in such a manner that it can be determined by a visual inspection that the alcoholic beverage 16 in the open container has been accessed. More particularly, as shown in FIGS. 3-5, a secondary closure system is provided at 30. The closure system 30 consists of a case 32, in the form of a flexible pouch, with a receptacle 34 for the entire container 10, including the wall structure 12 and the cork 20. The case 32 has an opening 36 through which the container 10 can be directed into the receptacle 34. The closure system 30 is operatively engaged with the container 10 with the container 10 directed fully into the receptacle 34, as shown in FIG. 3.

The closure system 30 has first and second different states. In the first state, the opening 36 is either partially or fully closed such that the alcoholic beverage 16 in the container 10 cannot be dispensed for consumption from the storage space 14. The first state is shown in FIGS. 3 and 5. With the closure system 30 in the second state therefor, the opening 36 is enlargeable, as shown in FIG. 4, to allow passage of the neck portion 28 of the container 10, or the entire container 10, therethrough to allow dispensing of the alcoholic beverage from the storage space 14 for consumption.

It is an objective of the present invention to require that the secondary closure system 30 be detectably changeable, as an incident of the closure system 30 changing from the first state into the second state, in a manner that the closure system 30 cannot be changed from the second state precisely back into the first state, as a consequence of which it can be determined by inspection that the closure system 30 was changed from the first state into the second state.

In the embodiment shown in FIGS. 3-5, the case 32 has facing wall parts 38,40 which can be connected to each other and, in this embodiment bonded, to close and seal the case opening 36. This bonding can be effected through the use of an adhesive or solvent 42, which effectively permanently bonds the wall parts 38,40 together, with the closure system 30 in the first state.

In attempting to change the closure system 30 from the first state into the second state, either the bond between the wall parts 38,40 must be broken or the case 32 must be torn/ruptured elsewhere to allow access to the neck portion 28 of the container 10.

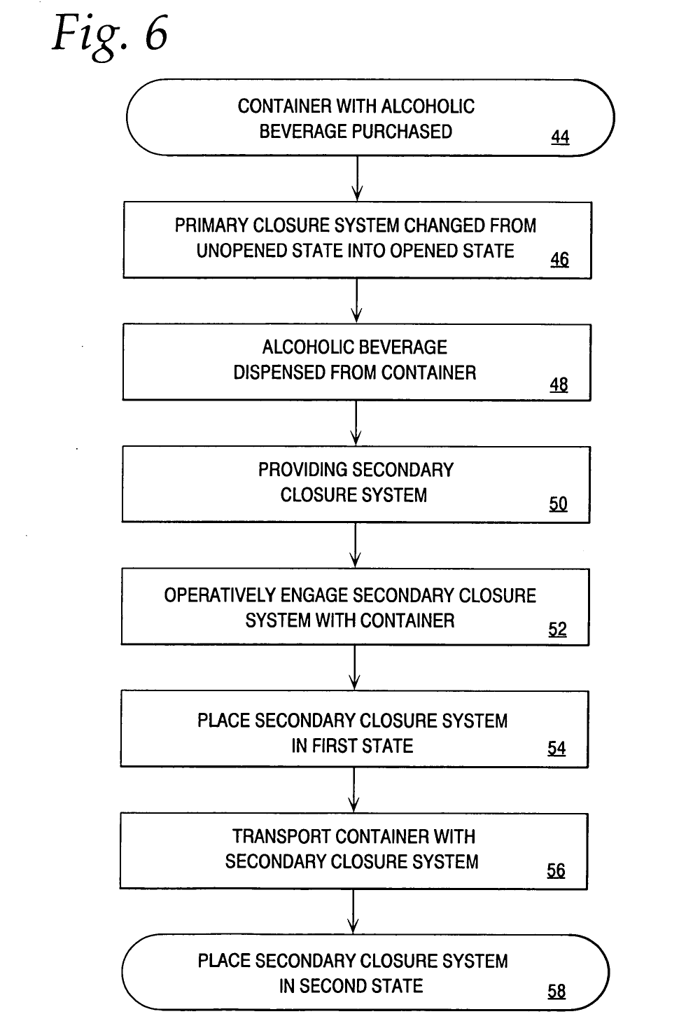

With the container 10 and the secondary closure system 30, the following sequence of events may occur, as shown in flow diagram form in FIG. 6. Initially, the container 10 with the alcoholic beverage therein is purchased, as shown at block 44. As shown at block 46, the primary closure system 20 is then changed from the unopened state into the opened state. This allows alcoholic beverage to be dispensed from the container for consumption, as indicated at block 48. At the point that some, but not all, of the alcoholic beverage has been dispensed form the container 10, the restaurateur/bar owner provides a secondary closure system, as shown at block 50. The secondary closure system 30 is then operatively engaged with the container 10, as shown at block 52. The secondary closure system 30 is placed in the first state, as shown at block 54, wherein the alcoholic beverage 16 cannot be dispensed for consumption from the container 10. The container 10 with the secondary closure system 30 operatively engaged therewith, and in the first state, can then be transported, as in a moving vehicle, as shown at block 56. At the appropriate destination, the secondary closure system can be placed in the second state, as shown at block 58, to allow the alcoholic beverage to be dispensed.

For the benefit of law enforcement personnel, it is possible to devise a system for licensed bar owners/restaurateurs to consistently, and in an identifiable manner, operatively engage the secondary closure system in the first state on premises in a manner that cannot be readily duplicated by the consumer. As just one example, the adhesive/solvent 42 may be activated by a special catalyst available only to the bar owners/restaurateurs. Alternatively, the adhesive/solvent 42 may be heat activated through a special tool used by the bar owners/restaurateurs. As another option, the bar owners/restaurateurs may be provided with an adhesive/solvent 42 that changes to a specific identifiable color with the wall parts 38,40 married, which color changes in the event that the wall parts 38,40 are subsequently separated.

As shown in FIG. 7, an adhesive/solvent 62 can be disposed between the wall parts 38,40, with the activation of the adhesive/solvent 62 and bonding of the wall parts 38,40 effected through use of a special tool 64 that is regulated by an appropriate governmental authority for controlled use by a bar owner/restaurateur. As just one example, the tool 64 might apply a compressive force on the wall parts 38,40 in a manner that produces identifiable impressions or indicia 66,68 on one or both of the wall parts 38,40, respectively.

In FIG. 8, a modified form of the wall parts 38′,40′, corresponding to the wall parts 38,40, is shown. The wall part 38′ has a male projection 72. The projection 72 is pressed into a complementary female receptacle 74 on the wall part 40′. The projection 72 can be seated in the receptacle 74 by a pressing operation. The projection 72 and receptacle 74 are configured so that once the projection 72 is in the receptacle 74, it is impossible to separate the wall parts 38′,40′ without tearing the material from which they are made.

The above are just examples of the myriad different ways contemplated by the invention for partially or fully closing the opening 36 of the secondary closure system 30 in a manner that it is clear that the secondary closure system 30 was placed into its first state in a drinking establishment and not subsequently changed into its second state by the consumer.

In other examples, as shown in FIGS. 9 and 10, the wall parts 38″,40″ on a closure system 30″ can be connected by a fastener 78, consisting of joinable male and female fastener parts 80,82, which are connected through the wall parts 38″,40″. More particularly, with the closure system 30″ in a second state of FIG. 9, the fastener parts 80,82 can be directed towards each other through the wall parts 38″,40″ to place the closure system 30″ in the first state, as shown in FIG. 10.

As shown in FIG. 11, the male fastener part 80 has external threads 84, with the female fastener part 82 having internal threads 86. The male and female fastener parts 80,82 are relatively rotated through special tools 88,90, respectively. The tool 88 has a special fitting to grippingly engage a head 92 on the male fastener part 80, with the tool 90 likewise engaging a head 94 on the female fastener part 82. Once connected, the male and female fastener parts 80,82 cannot be separated by relative rotation without use of the special tools 88,90. Accordingly, the only way to defeat the secondary closure system 30 would to be to tear the case 32″, which would be detectable by inspection.

In FIG. 12, an alternative form of male and female fastener parts 80′,82′ is shown which are intended to be permanently interengaged by translating the same towards and against each other, as indicated by the arrows 96,98.

A modified form of case is shown at 32′″ in FIGS. 13 and 14. The case 32′″ has a flap 96 which can be doubled back to close the case opening 36′″. Fasteners 78′″, having a construction as shown in FIGS. 11 and 12, are used to secure the folded flap 96 in the position shown in FIGS. 13 and 14, which represents the first state for the case 32′″.

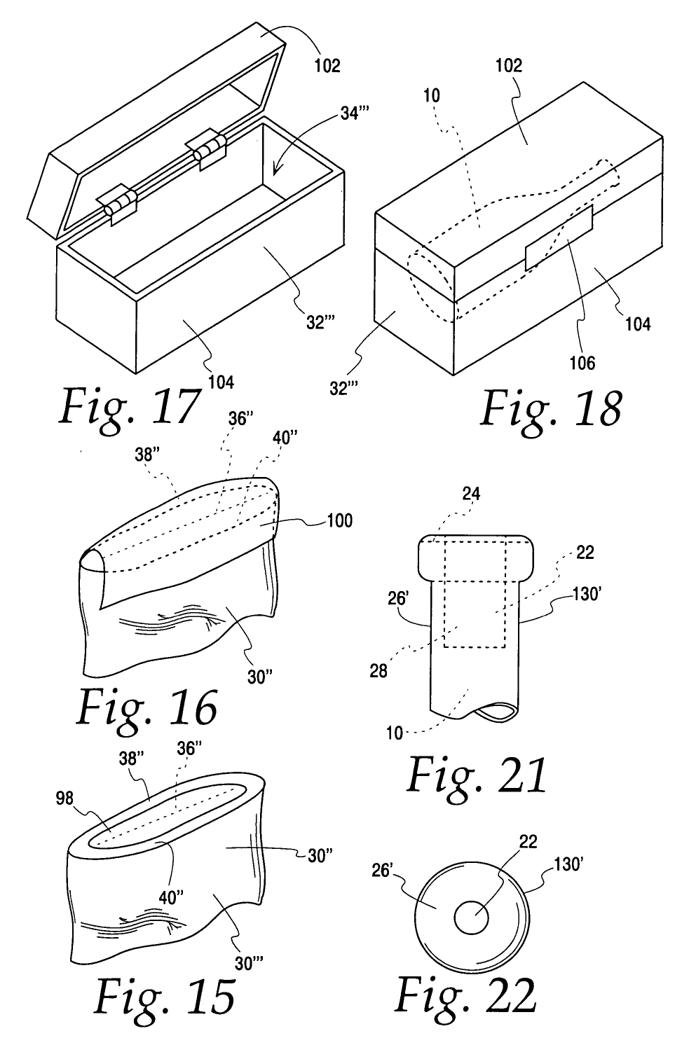

In FIG. 15, a modification of the closure system 30″ is shown wherein the walls parts 38″,40″ are maintained against each other, so that the opening 36″ is closed, by an element 98 bonded to the wall parts 38″,40″. The element 98 may be adhesively bonded to the wall parts 38″,40″ or may be molded thereagainst to produce a continuous form.

In FIG. 16, a further modification is shown wherein a flexible element 100 is wrapped in a U shape over the wall parts 38″,40″, which are captively maintained abutted to each other to close the opening 36″.

In FIGS. 17 and 18, a modified form of case 32′″ has a fixed configuration, with hingedly joined case parts 102,104 which can be relatively moved towards and away from each other, like the wall parts 38, 40, between the positions shown in FIGS. 17 and 18. With the case parts 102,104 relatively positioned as in FIG. 17, the case 32′″ is in its second state wherein the container 10 can be directed into a receptacle 34′″ defined thereby. By then relatively repositioning the case parts 102,104, as shown in FIG. 18, the case 32′″ is placed in its first state, wherein the container 10 cannot be accessed. The first state can be maintained, as by an element 106, which may be, for example, a sealing element that must be ruptured to allow the case 32′″ to be changed from its first state in FIG. 18, and to its second state in FIG. 17.

The invention contemplates utilizing closure systems that are not required to envelop the container 10. For example, as shown in FIGS. 19 and 20, the secondary closure system 130, performing the function of the closure system 30, consists of an element 132 which acts between the cork 20 and the wall structure 12 on the container 10 with the closure system 130 in the first state, as shown in FIG. 19. To change the closure system 130 from the first state of FIG. 19 into the second state of FIG. 20, the element 132 must be ruptured. The element 132 may be a molded element, and potentially one that incorporates some type of indicia 134, that is applied with the authority of a governmental agency to allow law enforcement personnel to identify an establishment legally authorized to prepare an open container for transportation in a motor vehicle.

In FIGS. 21 and 22, a secondary closure system 130′ is shown in the form of a wrapper 26′, which is applied to envelop the top of the container 10 so as to overlie the top edge 24 of the container 10 and a part of the cork 22. The wrapper 26′, as the wrapper 26 previously described, must be detectably altered, by tearing or removal, to allow the cork 22 to be removed from the neck portion 28 to dispense the contents of the container 10.

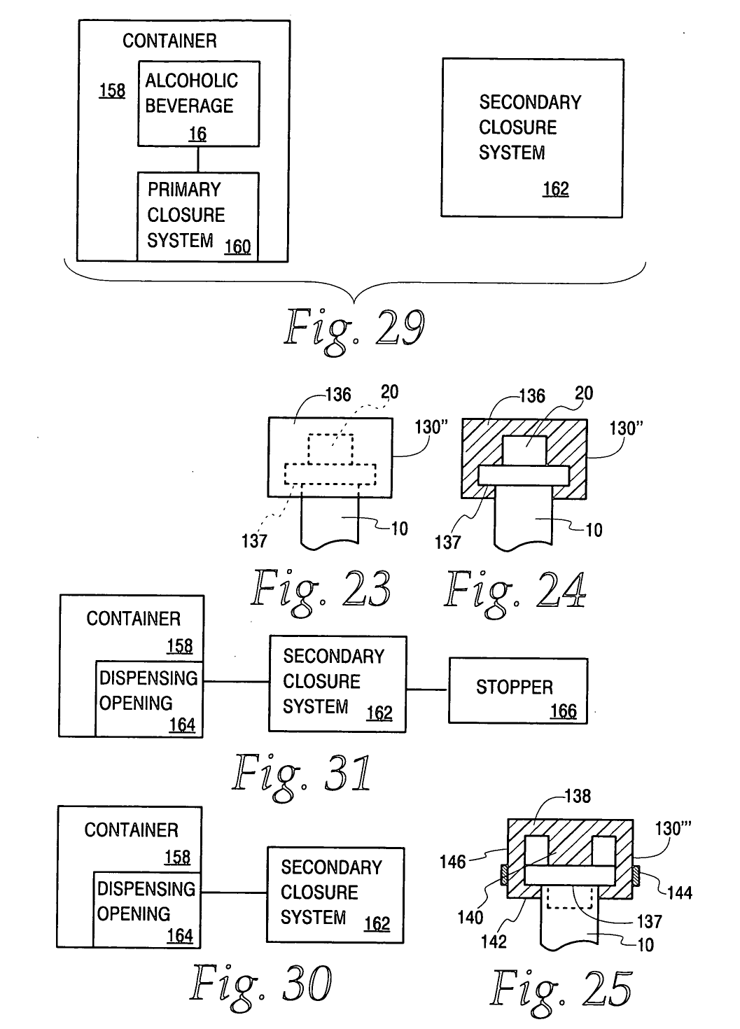

The secondary closure system 130, of the type shown in FIGS. 19 and 20, may take other forms, for example, that shown in FIGS. 23 and 24 at 130″, and that shown in FIG. 25 at 130′″.

The closure system 130″ consists of an element 136 that is placed, or molded, around the cork 20 and an annular, downwardly facing rim 137 on the container 10 to captively hold the cork 20 in place on the container 10.

The closure system 130′″ of FIG. 25 has an element 138 that has an integral cork/stopper 140 and an annular portions 142, which bears on the container rim 137, to prevent separation of the cork/stopper 140 by upward movement relative to the container 10. Separation of the element 138 from the container 10 may be further prevented as by the placement of a band 144 around the outer surface 146 of the element 138, to prevent deformation of the element 138 in a manner that might permit separation from the container 10. The band 144 may be applied by a special tool authorized by government license for use by bar owners/restaurateurs.

It should be understood that the invention is not limited to containers utilizing corks, as described heretofore. As shown in FIGS. 26 and 27, a modified form of container 10′ has a threaded cap 148 which is mated with threads 149 at the top of another part of the container 10.

The cap 148 has a jagged bottom edge 150 which, at the point of manufacture, is integral with a band 152 that is inseparable from the container 10′. By twisting the cap 148, the connection between the cap and band 152 is ruptured to evidence that the container 10′ has been changed from its unopened state into its opened state. The cap 148 can be reinstalled but will not have precisely the same appearance as it had at the time of manufacture by reason of the rupture between the jagged edge 10 and band 152.

The invention can be also be practiced with a container 10″, as shown in FIG. 28, having a removably tab 154, corresponding in function to the cork 20 and cap 148, described above. The tab 154 is initially joined to the remainder of the container 10″ at the time of manufacture so that the container 10″ is in its unopened state. By pulling on a ring 156, connected to the tab 154, the tab 154 can be separated from the rest of the container 10″ to place container 10″ in its opened state.

As noted previously, the above specific examples of structure for the various secondary closure systems, contemplated by the invention, are intended only to be exemplary in nature. More specifically, the invention contemplates virtually any type of secondary closure system for which there is a detectable change as the secondary closure system is changed from a first state into a second state, as described above. A generic depiction of the invention is shown in FIG. 29 wherein a container 158 has virtually any configuration capable of storing a supply of alcoholic beverage 16. The primary closure system 160 likewise could be virtually any type of closure system that can be changed from an unopened state into an opened state, with the latter permitting dispensing of the alcoholic beverage 16 for consumption. The secondary closure system 162 could in turn be virtually any structure that may be operatively engaged with the container 158 and which is changeable between first and second states as described above. Changing of the secondary closure system 162, from the first state into the second state, precludes changing of the secondary closure system 162 precisely back into the first state therefor, as a consequence of which it can be determined by inspection that the state of the secondary closure system 162 has been changed in such a manner that the alcoholic beverage 16 can be dispensed for consumption.

As shown in FIG. 30, the secondary closure system 162 be operatively engaged directly with the container 158 to prevent dispensing of the alcoholic beverage from a dispensing opening 164.

Alternatively, as shown in FIG. 31, the secondary closure system 162 may be operatively engaged with the container 158 through, or in conjunction with, a stopper 166 for the opening 164.

While the invention has been described with particular reference to the drawings, it should be understood that various modifications could be made without departing from the spirit and scope of the present invention.

1. In combination:
(a) a container having a storage space with a supply of an alcoholic beverage,
the container having an unopened state and an opened state,
the alcoholic beverage confined to the storage space with the container in the unopened state and capable of being dispensed from the storage space for consumption with the container in the opened state,
the container detectably changeable as an incident of the container being changed from the unopened state into the opened state in a manner that the container cannot be changed from the opened state precisely back into the opened state, as a consequence of which it can be determined by inspection that the container was changed from the unopened state into the opened state; and
(b) a closure system that is operatively engageable with the container and having first and second different states,
the closure system operatively engaged with the container and in the first state preventing dispensing of the alcoholic beverage in the container from the storage space for consumption,
the closure system detectably changeable as an incident of the closure system changing from the first state into the second state in a manner that the closure system cannot be changed from the second state precisely back into the first state, as a consequence of which it can be determined by inspection that the closure system was changed from the first state into the second state,
whereby after changing the container from the unopened state into the opened state, the closure system can be operatively engaged with the container and placed in the first state so that thereafter any dispensing of the alcoholic beverage from the container for consumption requires changing of the closure system from the first state into the second state which can be detected by inspection of the closure system.

2. The combination according to claim 1 wherein the closure system comprises a case with a receptacle into which the container is placed with the closure system operatively engaged with the container.

3. The combination according to claim 2 wherein the case has a flexible shape and an opening, the container movable through the opening with the closure system in the second state, the opening blocked sufficiently with the closure system in the first state that the container cannot be moved from the receptacle through the opening.

4. The combination according to claim 1 wherein the case comprises hinged case parts which are movable towards and away from each other to selectively place the closure system in the first and second states.

5. The combination according to claim 1 wherein the container has an opening through which the alcoholic beverage can be introduced into and dispensed from the storage space and comprises a cork directed into the container opening with the container in the unopened state and separated from the container with the container in the opened state.

6. The combination according to claim 5 wherein the container has a wall structure defining the opening and the closure system comprises at least one element that acts between the cork and the wall structure.

7. The combination according to claim 6 wherein the at least one element comprises a moldable material that is molded against the cork and the wall structure with the closure system in the first state.

8. The combination according to claim 7 wherein the moldable material is ruptured to change the closure system from the first state into the second state.

9. The combination according to claim 1 wherein the container has a wall structure defining an opening through which the alcoholic beverage can be introduced into and dispensed from the storage space for consumption and a cap that is repositionable relative to the wall structure to change the container between the opened and unopened states.

10. The combination according to claim 9 wherein the closure system comprises at least one element that acts between the cap and the wall structure.

11. The combination according to claim 10 wherein the at least one element comprises a moldable material that is molded against the cap and the wall structure with the closure system in the first state.

12. The combination according to claim 11 wherein the moldable material is ruptured to change the closure system from the first state into the second state.

13. The combination according to claim 3 wherein the case has first and second wall parts that are connected, each to the other, with the closure system in the first state.

14. The combination according to claim 13 wherein the first and second wall parts are bonded to each other with the closure system in the first state.

15. The combination according to claim 13 wherein the first and second wall parts are connected to each other through at least one flexible element with the closure system in the first state.

16. The combination according to claim 13 wherein the first and second wall parts are connected to each other through a molded element with the closure system in the first state.

17. The combination according to claim 13 wherein the first and second wall parts are snap-connected to each other with the closure system in the first state.

18. The combination according to claim 13 wherein the first and second wall parts are connected to each other through a fastener with the closure system in the first state.

19. The combination according to claim 18 wherein the fastener comprises joinable parts.

20. The combination according to claim 1 wherein the container has an opening through which the alcoholic beverage can be introduced into and dispensed from the storage space for consumption, and the closure system in the first state blocks the opening to prevent dispensing of alcoholic beverage in the container from the storage space for consumption.

21. A method of monitoring the dispensing of an alcoholic beverage from a container, said method comprising the steps of:
providing an alcoholic beverage in a storage space defined by a container having an unopened state and an opened state,
the alcoholic beverage confined to the storage space with the container in the unopened state and capable of being dispensed from the storage space for consumption with the container in the opened state;
changing the container from the unopened state into the opened state and thereby causing the container to be detectably changed in a manner that the container cannot be changed from the opened state precisely back into the unopened state, as a consequence of which it can be determined by inspection that the container was changed from the unopened state into the opened state;
providing a closure system that is operatively engageable with the container and having first and second different states;
placing the closure system in operative engagement with the container and in the first state so as to prevent dispensing of the alcoholic beverage in the container from the storage space for consumption; and
changing the closure system from the first state into the second state to allow the alcoholic beverage to be dispensed from the storage space for consumption and thereby causing the closure system to be detectably changed in a manner that the closure system cannot be changed from the second state precisely back into the first state, as a consequence of which it can be determined by inspection that the closure system was changed from the first state into the second state,
whereby after changing the container from the unopened state into the opened state, the closure system can be operatively engaged with the container and placed in the first state so that thereafter any dispensing of the alcoholic beverage from the container for consumption requires changing of the closure system from the first state into the second state which can be detected by inspection of the closure system.
